(19) United States
(12) Patent Application Publication
(10) Pub. No.: US 2007/0201458 A1
(43) Pub. Date: Aug. 30, 2007

(54) System and method for implementing ACLs using multiple hash-trie-key tables

(76) Inventors: Chris P. Thron, Austin, TX (US); Bernard Karl Gunther, Modbury Heights (AU); David B. Kramer, Cedar Park, TX (US)

Correspondence Address: FREESCALE - JVL;C/O VANLEEUWEN & VANLEEUWEN, P.O. BOX 90609, AUSTIN, TX, 78709-0609, US

(21) Appl. No.: 11/364,634

(22) Filed: Feb. 28, 2006

(51) Int. Cl. H04L 12/56

(52) U.S. Cl. 370/389; 370/230

(57) ABSTRACT

A method, data processing system, and computer program product are provided for searching for access rules included in access control lists (ACLs), such as those rules used to accept or deny packets received at a router. An incoming packet that includes several fields is received. An original key is formed from some of these fields. The original key is masked using predefined masks with each predefined mask corresponding to a different hash table. The masking of the original key results in masked keys where each of the masked keys corresponds to a different hash table. One or more hash tables are searched using the masked keys. The searching results in one or more possible rules. Each of the possible rules has a priority value. The possible rule that has the highest (best) priority is selected, and the selected rule is applied to the incoming packet.

### FIELD OF THE INVENTION

The present invention relates generally to a system and method for applying access control rules to packet traffic. More particularly, the present invention relates to a system and method for implementing Access Control Lists using hash-trie-key tables.

### RELATED ART

Access Control Lists (ACLs) are used in routers to control the flow of packet traffic. An ACL consists of a set of access control (AC) rules, where each rule specifies some of the fields in packets (some of the bits in these fields are typically wildcarded), and the action to be taken for packets which conform to the rule. Packet traffic throughput is screened in order to see which AC rule (if any) is to be applied to the packet.

One approach used to access rules within an ACL is using a multi-bit trie table structure. The multi-bit trie table structure was designed particularly for longest prefix matching applications. However, ACL's do not involve a prefix match, but rather matching of bits scattered throughout the key. The benefits of multi-bit trie in prefix matching is largely due to the early lookup termination when the prefix bits have been exhausted—but this advantage fails to gain much benefit for ACL's. Furthermore, the multi-bit trie structure can only examine a limited number of bits (typically 8) at each stage. This means that a verification of a 104-bit key will require over 10 stages. A lookup method that requires numerous stages, such as that used with the multi-bit trie table structure, is time consuming. With routers receiving large quantities of packets, a time consuming ACL lookup process reduces overall system efficiency and throughput.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a representation of the lookup procedure used to identify ACL rules;

FIG. 2 is a flowchart showing the steps taken during table construction;

FIG. 3 is a flowchart showing the steps taken in computing a hash mask, rule lists, and rule templates;

FIG. 4 is a flowchart showing the steps taken in constructing rule templates and information for early lookup termination;

FIG. 5 is a diagram showing one arrangement for the Data part of the key entry;

FIG. 6 is a flowchart showing a faster approach to modifying the lookup tables;

FIG. 7 is a flowchart showing an alternate approach for table creation;

FIG. 8 is a flowchart showing an alternate approach for table modification;

FIG. 9 is a flowchart showing the steps taken in computing a hash mask, rule lists, and rule templates for the alternate approach shown in FIG. 8;

FIG. 10 is a block diagram of a data processing system in which a preferred embodiment of the present invention may be implemented; and

FIG. 11 is a block diagram of a router in which a preferred embodiment of the present invention may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

The shortcomings of the prior art suggest the possibility of an algorithm based on exact match, not of the entire key, but of a specified subset of the bits in the ACL fields. On the surface there are a number of challenges with this new approach. First, the bits included in the specified subset are scattered throughout the key, making them somewhat more difficult to assemble. Second, if the number of bits used is in the subset is large, then a large lookup table is required. And third, wildcarding may cause “rule explosion”, that is, one rule may blow up into a large number of table entries, if a large number of wildcarded bits are included in the subset. The first two difficulties are addressed by using a hash-trie-key (HTK) lookup table approach, where the hash key is obtained by masking the selected bits in the original key. Alternatively, when the first difficulty is circumvented by other means, the bits in the specified subset may be assembled to form a key into a regular (flat) data table. The final difficulty is addressed by using multiple lookup tables in conjunction with different masks, such that the rules identified by each table have limited rule explosion.

The ACL rule identification in this approach is made based on a series of table lookups. Each table is built using a subset of the rules in the ACL. Hence each table validates or invalidates a subset of all the ACL rules. If the rule is validated in a table, in many cases the lookup process may be terminated, so it is not always necessary to look up in all the tables. It is also possible that the lookup process may terminate early even when no rule is validated, because rules for later tables may be eliminated from consideration if they are inconsistent with earlier lookups.

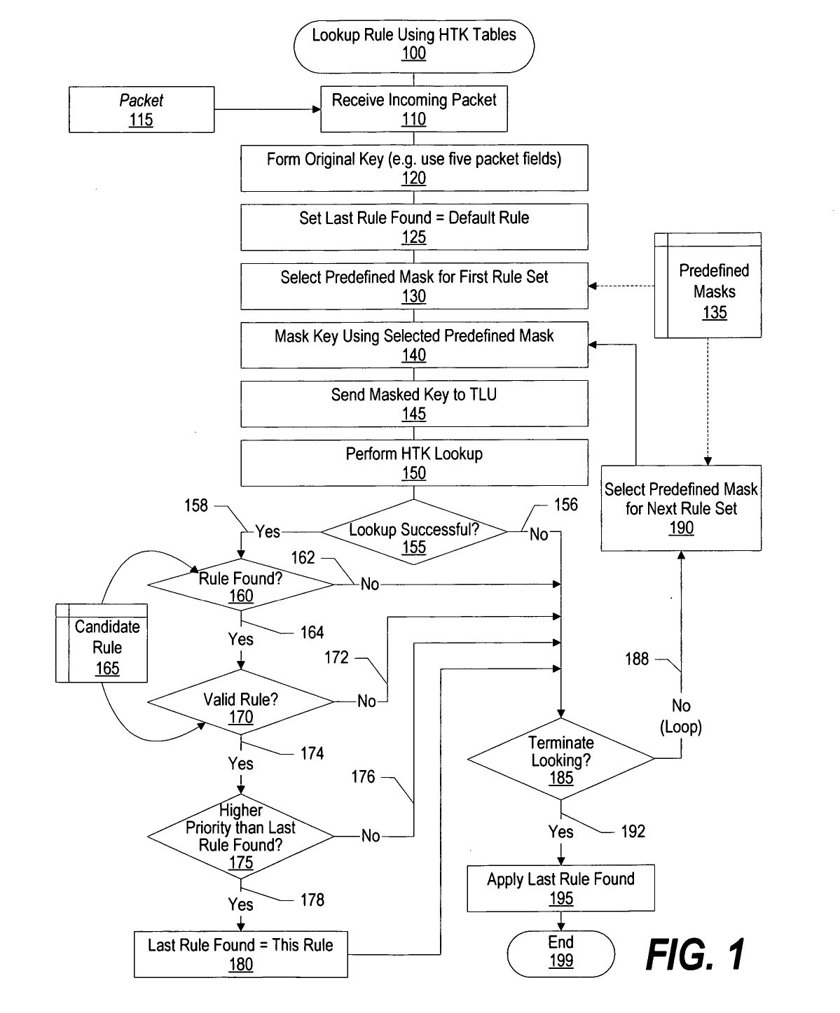

FIG. 1 is a flowchart showing the lookup procedure used to identify ACL rules. Processing commences at 100 whereupon, at step 110, packet 115 is received. The original key is formed by concatenating fields from the received packet (step 120). In one embodiment, five fields are used. In this embodiment, the five fields include the Source IP address, the Destination IP address, the Source port, the Destination port, and the Protocol. For each separate table lookup, a separate predefined mask is used (referred to herein as the “hash mask”) to mask the key before hashing. At step 125, the last rule found is set to a default rule. If no rules apply to the received packet then the default rule will be used. In a secure system, the default rule could be to “deny” the request, whereas in a permissive system, the default rule could be to “accept” the request.

Each rule set corresponds to a different predefined mask (a first rule set corresponds to a first predefined mask, a second rule set corresponds to a second predefined mask, etc.). Predefined masks are stored in predefined masks data store 135. The corresponding predefined mask is used to mask the original key forming a masked key and this masked key is used in the lookup using the corresponding rule set. At step 130, the first rule set and the first predefined mask are selected. At step 140, the key (formed in step 120) is masked using the first predefined mask forming a “masked key.”

In one embodiment, the predefined masks in the previous paragraph is used to select bits from the original key. The bits selected by a mask are assembled into a key, which is used as an index into a lookup table. In this embodiment, no hashing is used on the key. The lookup tables are not hash-trie-key tables, but rather simple indexed arrays of data.

In one embodiment, the hashmask is used to lookup rules in the table lookup unit (TLU) (step 145). Alternatively, the lookup could be performed using a traditional microprocessor. Each lookup returns a Data or Fail result (step 150). A determination is made as to whether the lookup result is Data or if it failed (decision 155). If the result is Data, decision 155 branches to “yes” branch 158 and the data is returned to the CPU for examination.

If the data suggests a possible rule, then decision 160 branches to “yes” branch 164 whereupon one of the rule sets 165 (the rule set corresponding to the predefined mask that is being used) is checked in CPU (decision 175) to determine if the rule is valid. If the rule is validated, then decision 170 branches to “yes” branch 174 whereupon, at decision 175, the validated rule is compared with the current final rule (the final rule is initialized to be the default rule in step 125). If the newly validated rule has a higher priority than the existing final rule, then decision 175 branches to “yes” branch 178 and the final rule is replaced with the newly validated rule at step 180.

On the other hand, if the lookup was successful, but the lookup did not identify a rule, then decision 160 branches to “no” branch 162. Likewise, if a rule was found but it is not a valid rule, then decision 170 branches to “no” branch 172. Finally, if a valid rule was found but its priority is not higher than the last rule found, then decision 175 branches to “no” branch 176. Each of these “no” branches branch to decision 185 which is used to determine whether to terminate the lookup procedure.

Following each lookup, a termination check is performed, to see if further hash lookups are necessary (decision 185). The termination decision is based on information contained within the Key entry, as well as table-specific information. If the termination information indicates a continue, then the termination indicator is updated, decision 185 branches to “no” branch 188 which loops back to select the next hash mask (step 190), and the same lookup procedure is followed for the next HTK table as described above. When the lookup procedure is terminated, decision 185 branches to “yes” branch 192 whereupon the final rule is applied to the packet (step 195) and processing ends at 199.

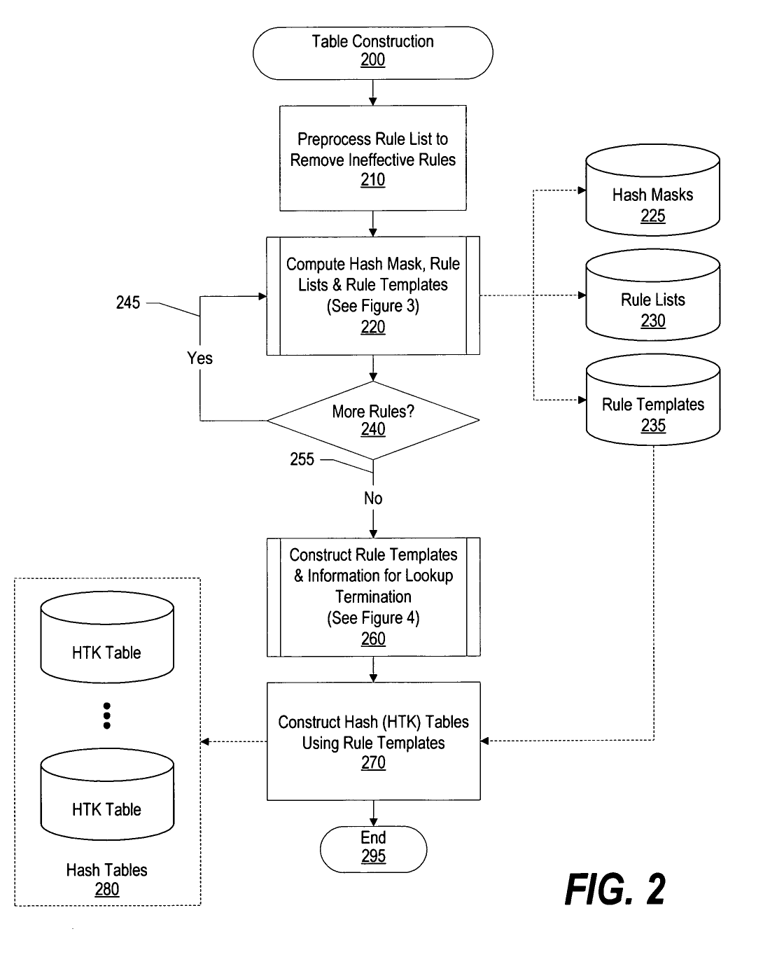

FIG. 2 is a flowchart depicting the overall construction process for the lookup tables. Processing commences at 200. First, the rule list is preprocessed in order to remove ineffective rules (step 210). The denotation ‘ineffective’ is applied to rules which are never invoked, because they are preempted by a rule of higher priority. Ineffective rules are useless, so they are removed from the ACL rule list. If they are not removed, they may lead to the creation of unnecessary additional lookup tables. In order to remove ineffective entries, the entire set of rules is parsed (set A). Ineffective rules are those which never have any effect on the lookup outcome, and are never applied to any packet. Hence let us denote:

A≡the entire set of rules

A₀≡the entire set of effective rules (i.e. ineffective rules have been removed).

Each lookup table is constructed based on a subset of the entire set of rules. These rules are referred to as the “included rules” for that lookup table. The following notation is used:

I_{j.}≡the set of included rules for the j'th lookup table.

(The j'th table lookup either validates or invalidates the rules in set I_{j.})

The included rule sets Iⱼ are constructed in sequence. After the construction of the first rule set I₁, the set of remaining rules is noted by A₁: that is, A₁≡A₀\I₁. The included set I₂ is a subset of the remaining rules A₁. The remaining rules following the construction of I₂ are those rules in A₁ which are not in I₂: hence A₂≡A₁\I₂. In summary:

A₁=A₀\I₁;

A₂=A₁\I₂;

A₃=A₂\I₃;

Note that the included rule sets {Iⱼ} are pairwise disjoint:

Iⱼ∩Iₖ=Ø if j≠k.

On the other hand, the remaining rule sets {Aⱼ} form a nested series:

A₀⊃A₁⊃A₂⊃ . . . .

In addition, each included rule set Iⱼ comprises two types of rules: first class rules and second class rules. The first class rules are those which may be conclusively validated by the j'th table lookup, and no further tablelookups are required. The second class rules require further lookups.

An ‘ineffective’ rule is characterized mathematically as follows. Let R be an ACL rule, and let M be the corresponding mask (using the format described in [1]). Then (R,M) is ineffective if there exists a rule, mask pair (R′,M′) such that:
(R′,M′) has higher priority than (R,M);
The mask M is more restrictive than M′ (i.e. M & M′=M);
The rules R′ and R agree on the more restrictive mask (i.e. R′&M=R&M).

In order to illustrate the concepts employed in the algorithm, an exemplary table of simplified rules is shown in Table 1. The rules are listed in order of decreasing priority—hence a lower rule index indicates a higher priority. Here the example assumes two 4-bit fields, which have been concatenated to form an 8-bit key. In practice, the key would be formed by a concatenation of multiple fields (typically Source IP, Destination IP, Source Port, Destination Port, and Protocol), and would be much longer (typically 104 bits).

TABLE 1
Simplified “ACL” rules

| Rule index | Rule | Rule mask |
|---|---|---|
| 1 | 10000111 | 11001111 |
| 2 | 10000110 | 11101110 |
| 3 | 10000110 | 11001111 |
| 4 | 11001111 | 11101111 |
| 5 | 11110000 | 11110000 |
| 6 | 10100000 | 11100000 |
| 7 | 10111110 | 11111110 |

In Table 1, a ‘0’ bit in the mask means the bit is arbitrary, and a ‘1’ bit means the bit is fixed. All the rules in Table 1 are “pre-masked”, so that if (Rⱼ, Mⱼ) is the j'th (rule,mask) pair we have:

Rⱼ & Mⱼ=Rⱼ. (where ‘&’ is the bitwise ‘and’ operation).

Ineffective rules may be identified as follows. Table 2 is constructed where the (m,n) entry of the table is defined as:
T(m,n)=MₙMₘ m>n.

TABLE 2
Identification of ineffective rules (1)

n

| m | 1 | 2 | 3 | 4 | 5 | 6 | 7 |
|---|---|---|---|---|---|---|---|
| 1 | | 0000 | 0000 | 0000 | 0000 | 0000 | 0000 |
| | | 0001 | 0000 | 0000 | 1111 | 1111 | 0001 |
| 2 | | | 0010 | 0000 | 0000 | 0000 | 0000 |
| | | | 0000 | 0000 | 1110 | 1110 | 0000 |
| 3 | | | | 0000 | 0000 | 0000 | 0000 |
| | | | | 0000 | 1111 | 1111 | 0001 |
| 4 | | | | | 0000 | 0000 | 0000 |
| | | | | | 1111 | 1111 | 0001 |
| 5 | | | | | | 0011 | 0000 |
| | | | | | | 0000 | 0000 |
| 6 | | | | | | | 0000 |
| | | | | | | | 0000 |

The entries which yield all 0's are indicated in bold. In these rule pairs, the lower-priority mask is more restrictive than the higher-priority mask. For these bolded (m,n) entries, Table 3 shows the computation of Mₘ&Rₙ, and the comparison with Rₘ:

TABLE 3
Identification of ineffective rules (2)

| m | n | Mₘ & Rₙ | Rₘ |
|---|---|---|---|
| 1 | 3 | 10000110 | 10000111 |
| 1 | 4 | 11001111 | 10000111 |
| 2 | 4 | 11001110 | 10000110 |
| 2 | 7 | 10101110 | 10000110 |
| 3 | 4 | 11001111 | 10000110 |
| 5 | 7 | 10110000 | 11110000 |
| 6 | 7 | 10100000 | 10100000 |

When Mₘ&Rₙ is equal to Rₘ for a given m and n, this indicates a rule pair for which the higher-priority rule always supersedes the lower-priority rule. For the example introduced in Table 1, Table 3 shows that Rule 6 supersedes Rule 7. In other words the higher-priority Rule 6 also applies whenever Rule 7 applies. Hence Rule 7 is ineffective, and can be dropped from the list of rules.

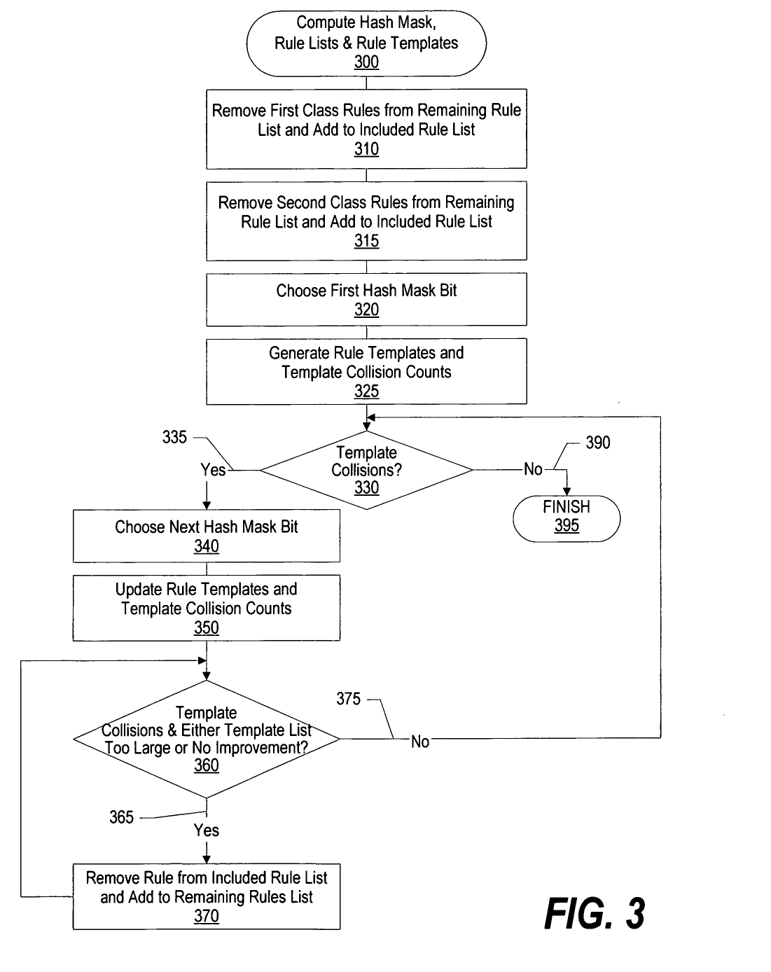

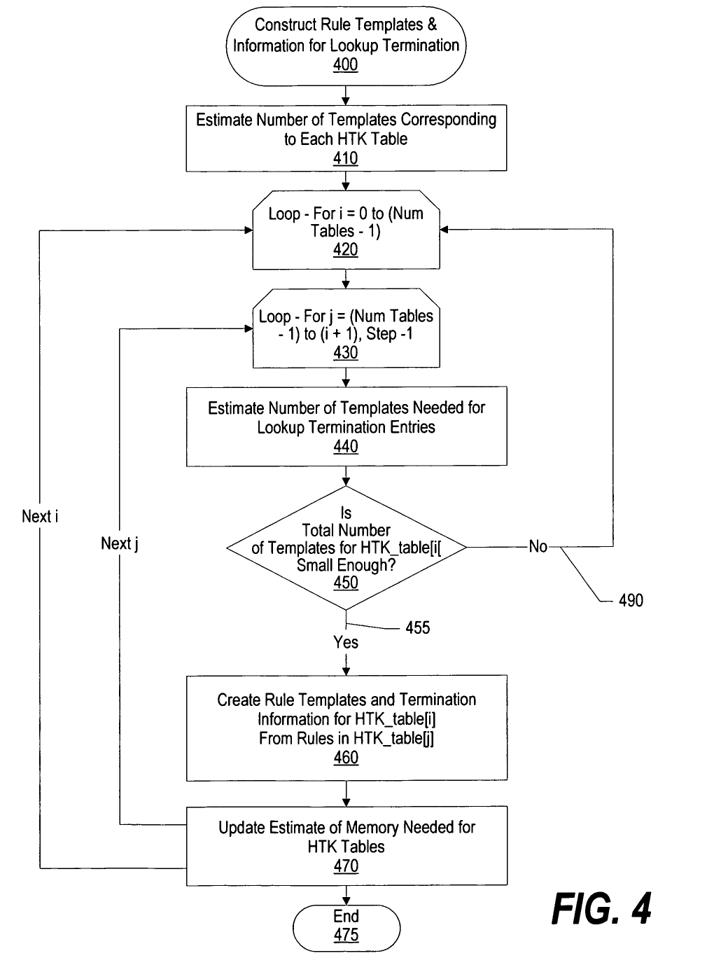

Returning to FIG. 2, in the next stage the hash mask, rules, and rule templates are computed (predefined process 220, see FIG. 3 and corresponding text for processing details). Predefined process 220 results in the creation of hash masks 225, rule lists 230, and rule templates 235. A determination is made as to whether there are more rules to process (decision 240). As long as there are rules to process, decision 240 branches to “yes” branch 245 which loops back to compute the hash mask, rule lists and rule templates. When all rules have been processed, decision 240 branches to “no” branch 255 whereupon rule templates and information that is used for early lookup termination is constructed (predefined process 260, see FIG. 4 and corresponding text for processing details). Next, hash tables 280 are constructed using the rule templates (step 270). Table construction processing thereafter ends at 295.

FIG. 3 is a flowchart depicting the steps used in computing the hash mask, rule lists, and rule templates. Each lookup table corresponds to a set of included rules which may be validated or invalidated by the corresponding table lookup. The included rules for a table are chosen in two stages. Processing commences at 300, whereupon, at step 310, “first-class” rules are removed from the remaining rule list and added to the included rule list. Step 310 involves identifying the “first class” rules from the list of remaining rules, as follows. For the purpose of this construction, a pair of rules is said to be “resolvable” if no key validates both rules. Otherwise, the pair is said to be “unresolvable” (so in this case at least one key validates both rules).

Unresolvable pairs from the rule set in Table 1 are identified with the aid of Table 4, which is constructed according to the following rule:

TABLE 4
Resolvability matrix for rules in Table 1.

n

| m | 1 | 2 | 3 | 4 | 5 | 6 |
|---|---|---|---|---|---|---|
| 1 | | 1000 | 1000 | 1000 | 1000 | 1000 |
| | | 0110 | 0111 | 0111 | 0000 | 0000 |
| 2 | 1000 | | 1000 | 1000 | 1000 | 1000 |
| | 0110 | | 0110 | 0110 | 0000 | 0000 |
| 3 | 1000 | 1000 | | 1000 | 1000 | 1100 |
| | 0110 | 0110 | | 0110 | 0000 | 0000 |
| 4 | 1100 | 1100 | 1100 | | 1100 | 1100 |
| | 0000 | 1110 | 1110 | | 0000 | 0000 |
| 5 | 1100 | 1110 | 1100 | 1110 | | 1110 |
| | 0000 | 0000 | 0000 | 0000 | | 0000 |
| 6 | 1000 | 1010 | 1000 | 1010 | 1010 | |
| | 0000 | 0000 | 0000 | 0000 | 0000 | |

T(m,n)=Rₘ & Mₙ m≠n.

Note that since the rules are pre-masked, this means that: T(m,n)=Rₘ & (Mₘ & Mₙ) m≠n.

In Table 4, the cell values are bolded for which T(m,n)=T(n,m). This means Rules m and n agree on their common mask, so they have at least one key in common, which in turn implies they are unresolvable. For instance, entries (1,2) and (2,1) are bolded in Table 4, and the key 10000111 satisfies both Rule 1 and Rule 2.

The first class rules may be characterized as follows:
(1) The first-class rule set is completely resolvable, i.e. any key validates at most one rules in the first-class rule set;
(2) Each first-class rule is “top priority”, i.e., any other unresolvable rule (which according to (1) cannot be first-class) has a lower priority.
(3) The first-class rule set is the unique maximal set of rules which satisfies (1) and (2). (It can be shown by construction that there is a unique maximal set).

If a first-class rule is validated, no further lookup is necessary, because all higher-priority rules must be invalid. In the case of Table 1, using Table 4 it can be seen that Rules 1,4, and 5 form the first-class set.

Returning to FIG. 3, in step 315, second class rules are removed from the remaining rule list and added to the included rule list. The second-class rules are chosen after the first-class rules have been selected and removed from the remaining rule list. The second-class rules satisfy the following conditions:
(1′) The union of first-class and second-class sets (i.e. the “included set”) is completely resolvable, as defined in (1) above; and
(2′) The second-class set is a maximal set of rules which satisfies (1′).

The second-class set is not necessarily uniquely defined, for in some cases the set of first-class rules may be extended in multiple ways to form a maximal completely resolvable set. Note that if a second-class rule is validated, further lookups are used to make sure that no other higher-priority rule also matches the key. In contrast, a first-class rule uses no further lookups.

In the example provided, Rule 3 is a second-class rule, because it is resolvable with the first-class rules 1,4, and 5. The purpose of the second-class set is to augment the included rule set, so that the table may be used to validate more rules.

Returning to FIG. 3, at step 320, the first hash mask bit is chosen and at step 325, rule templates and collision counts are generated. Each lookup table uses a hash mask, which is applied to the original key to create a masked key for that particular lookup table. At step 320 the first hash mask bit is chosen. In the case of the example introduced in Table 1, this is done as follows: For each of the 8 bit positions, the rules which are consistent with a ‘0’ or ‘1’ in that position are identified (if the corresponding mask bit is ‘0’ then both ‘0’ and ‘1’ are consistent). Table 5 summarizes the results of choosing the first hash bit for the example data:

TABLE 5
Bits ‘0’ & ‘1’ consistency with rules at various bit positions

| | Bit pos. | | | | | | | | | | | | | | | |
|---|---|---|---|---|---|---|---|---|---|---|---|---|---|---|---|---|
| | 1 | | 2 | | 3 | | 4 | | 5 | | 6 | | 7 | | 8 | |
| Rule# | 0 | 1 | 0 | 1 | 0 | 1 | 0 | 1 | 0 | 1 | 0 | 1 | 0 | 1 | 0 | 1 |
| 1 | N | Y | Y | N | Y | Y | Y | Y | Y | N | N | Y | N | Y | N | Y |
| 3 | N | Y | Y | N | Y | Y | Y | Y | Y | N | N | Y | N | Y | Y | N |
| 4 | N | Y | N | Y | Y | N | Y | Y | N | Y | N | Y | N | Y | N | Y |
| 5 | N | Y | N | Y | N | Y | N | Y | Y | Y | Y | Y | Y | Y | Y | Y |
| #Y (0/1) | 0 | 4 | 2 | 2 | 3 | 3 | 3 | 4 | 3 | 2 | 1 | 4 | 1 | 4 | 2 | 3 |

| | | | | | | | | |
|---|---|---|---|---|---|---|---|---|
| MAX | 4 | 2 | 3 | 4 | 3 | 4 | 4 | 3 |

It follows from the table that bit position 2 corresponds to the minimax value for number of consistent bits. Therefore, bit #2 is chosen as the first bit in the mask.

To find the next bit in the mask, a similar set of tables is created for the remaining bit positions (1-8, with 2 excluded). This time the consistency of each of the possible patterns ‘00’, ‘01’, ‘10’, and ‘11’ is determined for bit 2 and the given bit position. Note that an ‘N’ in Table 5 corresponding to bit ‘0’ will yield two ‘N’ entries in Table 6, while a ‘Y’ entry means the corresponding Table 6 entries will agree with Table 5. The analogous statements hold for bit ‘1’ and Table 7.

TABLE 6
Patterns ‘00’ & ‘01’ consistency with rules at (2, x) bit positions

| | Bit pos. | | | | | | | | | | | | | |
|---|---|---|---|---|---|---|---|---|---|---|---|---|---|---|
| | (2, 1) | | (2, 3) | | (2, 4) | | (2, 5) | | (2, 6) | | (2, 7) | | (2, 8) | |
| Rule# | 00 | 01 | 00 | 01 | 00 | 01 | 00 | 01 | 00 | 01 | 00 | 01 | 00 | 01 |
| 1 | N | Y | Y | Y | Y | Y | Y | N | N | Y | N | Y | N | Y |
| 3 | N | Y | Y | Y | Y | Y | Y | N | N | Y | N | Y | Y | N |
| 4 | N | N | N | N | N | N | N | N | N | N | N | N | N | N |
| 5 | N | N | N | N | N | N | N | N | N | N | N | N | N | N |
| #Y | 0 | 2 | 2 | 2 | 2 | 2 | 2 | 0 | 0 | 2 | 0 | 2 | 1 | 1 |
| (0/1) | | | | | | | | | | | | | | |

| | | | | | | | |
|---|---|---|---|---|---|---|---|
| MAX | 2 | 2 | 2 | 2 | 2 | 2 | 1 |
| SUM | 2 | 4 | 4 | 2 | 2 | 2 | 2 |

TABLE 7
Patterns ‘10’ & ‘11’ consistency with rules at (2, x) bit positions

| | Bit pos. | | | | | | | | | | | | | |
|---|---|---|---|---|---|---|---|---|---|---|---|---|---|---|
| | (2, 1) | | (2, 3) | | (2, 4) | | (2, 5) | | (2, 6) | | (2, 7) | | (2, 8) | |
| Rule# | 10 | 11 | 10 | 11 | 10 | 11 | 10 | 11 | 10 | 11 | 10 | 11 | 10 | 11 |
| 1 | N | N | N | N | N | N | N | N | N | N | N | N | N | N |
| 3 | N | Y | Y | Y | Y | Y | Y | N | N | Y | N | Y | Y | N |
| 4 | N | Y | N | N | Y | N | N | Y | N | Y | N | Y | N | Y |
| 5 | N | Y | N | Y | N | Y | N | Y | Y | Y | Y | Y | Y | Y |
| #Y | 0 | 3 | 1 | 2 | 2 | 2 | 1 | 2 | 1 | 3 | 1 | 3 | 2 | 2 |
| (0/1) | | | | | | | | | | | | | | |

| | | | | | | | |
|---|---|---|---|---|---|---|---|
| MAX | 3 | 2 | 2 | 2 | 3 | 3 | 2 |
| SUM | 3 | 3 | 4 | 3 | 4 | 4 | 4 |

Bit positions 3,4,5, and 8 all yield the minimum overall max value 2 (overall max is the maximum of MAX values from Table 6 and Table 7). However of these four bit positions, position 5 has the minimum overall sum (overall sum is the sum of SUM values from Table 6 and Table 7). Hence bit 5 is chosen as the next bit position in the hash mask.

Finding the next bit position would require four tables similar to Table 5 in order to determine 3-bit pattern incidences. Continuing in this fashion, it is eventually determined that bit positions 2,5,8,3 are sufficient to resolve all four rules, as shown in Table 8. The various possible bit patterns are referred to as “templates”. Hence for this choice of bit positions, all templates correspond to at most one rule.

TABLE 8
Bit templates and rule incidences for final hash mask

| Bit #2 | Bit #5 | Bit #8 | Bit #3 | Rule # |
|---|---|---|---|---|
| 0 | 0 | 0 | 0 | 3 |
| 0 | 0 | 1 | 0 | 1 |
| 0 | 1 | 0 | 0 | — |
| 0 | 1 | 1 | 0 | — |
| 0 | 0 | 0 | 1 | 3 |
| 0 | 0 | 1 | 1 | 1 |
| 0 | 1 | 0 | 1 | — |
| 0 | 1 | 1 | 1 | — |
| 1 | 0 | 0 | 0 | — |
| 1 | 0 | 1 | 0 | — |
| 1 | 1 | 0 | 0 | — |
| 1 | 1 | 1 | 0 | 4 |
| 1 | 0 | 0 | 1 | 5 |
| 1 | 0 | 1 | 1 | 5 |
| 1 | 1 | 0 | 1 | 5 |
| 1 | 1 | 1 | 1 | 5 |

In the final lookup table, each template associated with a rule will correspond to a Key entry. If there are too many such templates, the number of table entries may be too large and cause problems with processing time and/or memory. In Table 8, it was determined that 9 templates (bit pattern for the hash mask bits) correspond to included rules. At first sight this may seems unusual because there are only 4 included rules. However, the reason becomes clear upon examination of Table 8: some rules correspond to multiple templates. In particular, Rule 5 corresponds to 4 separate templates, which would give rise to four separate Key entries.

In order to avoid table size difficulties, the algorithm includes the possibility of removing rules from the included set. Returning to FIG. 3, a determination is made as to whether there are template collisions (decision 330). If there are template collisions, decision 330 branches to “yes” branch 335 to resolve the collisions. At step 340, the next hash mask bit is chosen. The rule template collision counts are then updated at step 350. A determination is made as to whether there are template collisions and either (1) the template list is too large, or (2) there is no improvement (decision 360). If this condition is true, then decision 360 branches to “yes” branch 365 whereupon the rule is removed from the included rule list and added to the remaining rules list at step 370. Processing then loops back to continue removing rules until either there are no template collisions or either (1) the template list is not too large, or (2) there is no further improvement by removing the rule, at which point decision 360 branches to “no” branch 375. Processing continues until there are no further template collisions, at which point decision 330 branches to “no” branch 390 and processing ends at 395.

Template collisions can be illustrated with an example. Suppose a threshold of 5 distinct templates is set corresponding to rules. During the construction of the hash mask, this threshold is exceeded at the 3-bit stage. Table 9 shows the bit templates and rule incidences at this stage, with hash mask bits 2,5,8.

TABLE 9
Bit templates and rule incidences with 3-bit hash mask

| Bit #2 | Bit #5 | Bit #8 | Rule # |
|---|---|---|---|
| 0 | 0 | 0 | 3 |
| 0 | 0 | 1 | 1 |
| 0 | 1 | 0 | — |
| 0 | 1 | 1 | — |
| 1 | 0 | 0 | 5 |
| 1 | 0 | 1 | 5 |
| 1 | 1 | 0 | 5 |
| 1 | 1 | 1 | 4, 5 |

It is clear that if Rule 5 is removed from the list, then there is no rule collision among the 3 remaining rules (1,3,4). Furthermore, only three templates will be associated with rules, as shown in Table 9.

TABLE 10
Bit templates and rule incidences with Rule 5 removed

| Bit #2 | Bit #5 | Bit #8 | Rule # |
|---|---|---|---|
| 0 | 0 | 0 | 3 |
| 0 | 0 | 1 | 1 |
| 0 | 1 | 0 | — |
| 0 | 1 | 1 | — |
| 1 | 0 | 0 | — |
| 1 | 0 | 1 | — |
| 1 | 1 | 0 | — |
| 1 | 1 | 1 | 4 |

The rule removal procedure removes one rule at a time, using a metric criterion to decide which rule to remove. Only rules involved in collision are candidates for removal. Second-class rules are favored for removal, as are rules of low priority.

The simplified ACL rules example is continued using the bit templates in Table 10. An initial hash mask (bits 2,5,8) is constructed corresponding to an initial set of rules (1,3,4). However, the remaining rules (2,5 and 6) still need to be accommodated (recall that Rule 5 was removed from the included set to reduce memory requirements). In order to do so, the construction procedure detailed above is repeated on the new remaining rule set {2,5,6}. In this case, from Table 4 it is clear that Rule 2 and Rule 6 are not resolvable, and so they will require two separate lookup tables. Hash masks are chosen for these two tables. For the second table with rules {2,5}, bit 2 is chosen which resolves them. For the third rule table with the single Rule 6, bits 1,2,3 are chosen which are the un-wildcarded bits of Rule 6. The three lookup tables are referred to as HTK_Table[j], j=0,1,2.

Referring back to FIG. 2, predefined process 260 was used to construct rule templates and information used for lookup termination. FIG. 4 details the steps taken during predefined process 260. Processing commences at 400 whereupon, at step 410, initial estimates of the number of templates for all the lookup tables are made. A nested loop is set up to first loop through all of the lookup tables (step 420) and, second, to loop through the tables following the selected table. Loop step 420 sets up the outer loop to loop through all of the tables (0 to number of tables −1). Loop step 430 sets up the inner loop to loop through the tables following the selected tables in reverse order ((number of tables −1) to (i+1), step −1), where “i” represents the currently selected table from the outer loop.

At step 440, the number of templates corresponding to termination entries is estimated. A determination is made as to whether the number of templates is too large for the table (decision 450). If sufficient memory remains, decision 450 branches to “yes” branch 455 whereupon, at step 460, rule templates and termination information are created for the currently selected table (HTK_table[i]) from rules included in the table selected in the inner loop (HTK_table[j]). At step 470, the estimate of the number of templates corresponding to HTK_table[i] is updated. Processing then loops back to continue processing the various tables (the inner loop continues decrementing until it is satisfied—when the inner loop is satisfied, the outer loop is incremented until all the tables have been processed). If both the inner and outer loops have been satisfied, then processing ends at 475.

Returning to decision 450, if the number of templates is too large, decision 450 branches to “no” branch 490 and processing ends at 490. Obviously, the more tables that are processed with sufficient memory remaining, the greater number of rule templates and termination information that will be created for assisting in early termination of ACL lookups using the HTK tables.

The simplified ACL example introduced in Table 1 and expanded in subsequent tables can be used to illustrate the creation of rule templates and termination information. According to the iteration scheme shown in FIG. 4, processing starts with i=0 and j=2. HTK_Table[0] has hash mask {2,5,8}, and HTK_Table[2] has just one rule, Rule 6. Of the three bits {2,5,8}, two of them (5 and 8) are wildcarded for Rule 6. This means that four rule templates (4=2*2) will be associated with Rule 6. These rule templates are identified as {00,101,110,111}. It follows that other templates will never have to be looked up in the third table. If it has been estimated that the additional templates will not make HTK_Table[0] too large, then this template information in HTK_Table[0] is stored. A default termination index of 1 is then associated with HTK_Table[0]: that is, unless otherwise indicated by the lookup in HTK_Table[0], no lookup past HTK_Table[1] is required.

The next iteration in FIG. 4 has i=0 and j=1. In this case there are two rules {2,5} associated with HTK_Table[1], which have 1 and 2 wildcarded bits among HTK_Table[0]'s hash mask bits {2,5,8} respectively. It follows that two and four rule templates will be associated with Rules 2 and 5, respectively. A decision may be made that adding six templates will make HTK_Table[0] too large. On the other hand, if this information is included in HTK_Table[0], then a default termination index of 0 can be associated with HTK_Table[0].

The storage of termination information is explained in more detail in the following tables and descriptions. The information gained in the previous stages of the algorithm shown in FIG. 4 are organized into three array structures: TableEntryA, TableEntryB and HTK_Table. The structure TableEntryA contains entry-specific information for HTK table entries computed in FIG. 3, while TableEntryB corresponds to HTK table entries computed in FIG. 4. The structure HTK_Table contain table-specific information. The fields for these three structures are described in Tables 11, 12, and 13, below.

TABLE 11
Fields for TableEntryA data structure

| Field name | Field meaning |
|---|---|
| TableEntryA.table[n] | Table corresponding to n'th entry in list |
| TableEntryA.tmplt[n] | Mask bit template corresponding to entry |
| TableEntryA.rule[n] | Index of rule corresponding to entry |
| TableEntryA.class[n] | 0 or 1 corresponding to whether rule is |
| | first/second class |

TABLE 12
Fields for TableEntryB data structure

| Field name | Field meaning |
|---|---|
| TableEntryB.table[n] | Table corresponding to n'th entry in list |
| TableEntryB.tmplt[n] | Mask bit template corresponding to entry |
| TableEntryB.rule[n] | Index of rule corresponding to entry |
| TableEntryB.trm[n] | Index of table for lookup termination |

TABLE 13
Fields for HTK_Table data structure

| Field name | Field meaning |
|---|---|
| HTK_Table.keylen[n] | Length of hashed key into n'th table (hence |
| | the number of hash entries in the n'th table |
| | is equal to 2^{HTK}_{^{—Table.keylen}}^{[n]}.) |
| HTK_Table.hashmask[n] | Mask which is applied to original key before |
| | hashing and lookup in n'th table |
| HTK_Table.lkp_trm[n] | Default termination index associated with |
| | n'th HTK table (hence lookup terminates in |
| | HTK_Table.lkp_trm[n]'th table if |
| | n'th table lookup result is Fail.) |

In the simple ACL rules example introduced in Table 1, the data structures have values as shown in Table 14, below. Here the 3-bit hash mask displayed in Table 9 for HTK_Table[0] has been used. In addition, these tables assume that lookup termination information for HTK_Table[0] has only been added from HTK_Table[2].

TABLE 14
Values for TableEntryA data structure

| n | table | Template | Rule | Class |
|---|---|---|---|---|
| 0 | 0 | 000 | 3 | 1 |
| 1 | 0 | 001 | 1 | 0 |
| 2 | 0 | 111 | 4 | 0 |
| 3 | 1 | 0 | 2 | 0 |
| 4 | 1 | 1 | 5 | 0 |
| 5 | 2 | 101 | 6 | 0 |

TABLE 15
Values for TableEntryB data structure

| n | table | Template | Rule | Termination (trm) |
|---|---|---|---|---|
| 0 | 0 | 100 | 6 | 2 |
| 1 | 0 | 101 | 6 | 2 |
| 2 | 0 | 110 | 6 | 2 |
| 3 | 0 | 111 | 6 | 2 |
| 4 | 1 | 0 | 6 | 2 |

TABLE 16
Values for HTK_Table data structure

| n | keylen | hashmask | lkp_trm |
|---|---|---|---|
| 0 | 4 | 01001001 | 1 |
| 1 | 2 | 01000000 | 1 |
| 2 | 1 | 11100000 | 2 |

The values of keylen in Table 16 are related to the size of the corresponding HTK table. If keylen is n, then the number of hash entries in the HTK table is 2ⁿ. The larger the value of keylen, the smaller the probability of hash collisions.

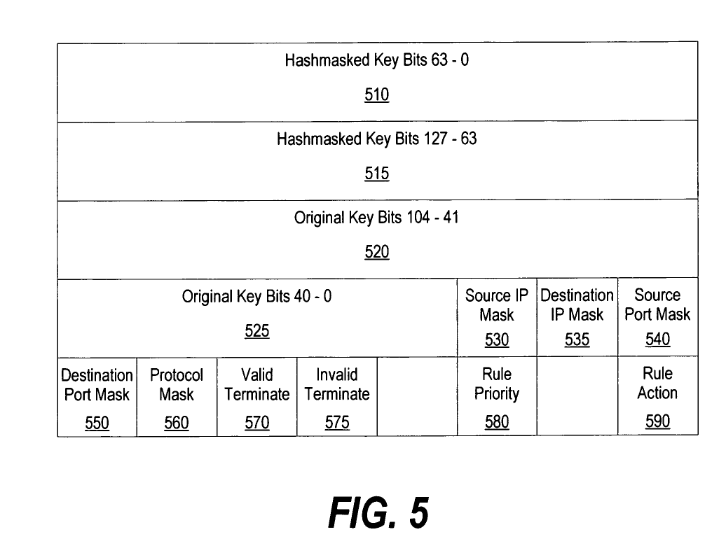

Referring back to FIG. 2, step 270 constructed HTK tables, the final stage of the algorithm is the construction of HTK tables using the information gained in the previous stages. Each HTK table includes four types of entries: hash (8 bytes), trie (8 bytes), key (40 bytes) and fail (8 bytes). The Data part of the key entry is arranged as shown in FIG. 5. The different fields depicted in FIG. 5 are described in Table 17, below:

TABLE 17
HTK table key entry data fields description

| Field | Description | Bytes |
|---|---|---|
| Hashmasked key | Original key (concatenated fields) with | 16 |
| (fields 510 and 515) | hash mask applied | |
| Rule key | Concatenated fields for rule (unmasked) | 13 |
| (fields 520 and 525) | | |
| Source IP mask | Number of prefix mask bits for source IP | 1 |
| (field 530) | address | |
| Destination IP mask | Number of prefix mask bits for destination | 1 |
| (field 535) | IP address | |
| Source port mask | Number of prefix mask bits for source port | 1 |
| (field 540) | address | |
| Destination port | Number of prefix mask bits for destination | 1 |
| mask | port address | |
| (field 550) | | |
| Protocol mask | Number of prefix mask bits for protocol | 1 |
| (field 560) | | |
| Valid termination | Index of table to terminate lookup, if | 1 |
| (field 570) | rule is validated | |
| Invalid termination | Index of table to terminate lookup, if | 1 |
| (field 575) | rule is invalidated | |
| Rule priority | Priority of rule associated with key entry | 3 |
| (field 580) | | |
| Action | Action associated with rule | 1 |
| (field 590) | | |

The HTK tables are constructed entry-by-entry. First, the entries corresponding to TableEntryA are added (see Table 11), and then the entries corresponding to TableEntryB are added (see Table 12). When TableEntryA entries are added, the values for the key entry data fields in Table 17 are obtained as follows.
The hashmasked key is the template TableEntryA.tmplt[n] applied to the masked bits given by HTK_Table.hashmask[TableEntryA.table[n]].
The rule key is the rule with index TableEntryA.rule[n].
The number of prefix mask bits for Source IP, Destination IP, etc. are obtained from the mask of the rule with index TableEntryA.rule[n].
The ‘Valid termination’ field is set equal to TableEntryA.table[n] if TableEntryA.class[n]=0, or HTK_Table.lkp_trm[TableEntryA.table[n]] if TableEntryA.class[n]=1.
The ‘Invalid termination’ field is set equal to HTK_Table.lkp_trm[TableEntryA.table[n]].
The ‘Rule priority’ field is set equal TableEntryA.rule[n]*256. (the ‘256’ is used to facilitate rule addition, as explained in further detail below).
The ‘Rule action’ field is set equal to the action associated with TableEntryA.rule[n].

Note that no key entry overwriting will occur when the TableEntryA entries are added, because each template-table combination is unique.

When TableEntryB entries are added, some of these entries may coincide with existing HTK key entries (i.e. with the same hashmasked key). Hence there are two cases to consider: (1) when a new key entry is being added; and (2) when an existing key entry is being modified.

When a new key entry is being added (case (1)), the values for the key entry data fields shown in FIG. 5 and described in Table 17 are obtained as follows.
The hashmasked key is the template TableEntryB.tmplt[n] applied to the masked bits given by HTK_Table.hashmask[TableEntryB.table[n]].
The ‘Rule key’ field, and five ‘number of prefix mask bits’ fields are set equal to 0.
The ‘Valid termination’ field is set equal to 0.
The ‘Invalid termination’ field is set equal to TableEntryB.trm[n].
The ‘Rule priority’ field is set equal to 0×ffffff (lowest priority).
The ‘Rule action’ field is set equal to 0.

When an existing key entry is being modified (case (2)), the values for the key entry data fields in shown in FIG. 5 and described in Table 17 are obtained as follows.
The hashmasked key is the template TableEntryB.tmplt[n] applied to the masked bits given by HTK_Table.hashmask[TableEntryB.table[n]].
The ‘Rule key’ field, and five ‘number of prefix mask bits’ fields are not changed.
The ‘Valid termination’ field is not changed if 256*TableEntryB.rule[n] is greater than the existing ‘Rule priority’ field in the key. Otherwise, the ‘Valid termination’ field is set equal to the maximum of TableEntryB.trm[n] and the existing ‘Valid termination’ field.
The ‘Invalid termination’ field is set equal to the maximum of TableEntryB.trm[n] and the existing ‘Invalid termination’ field.
The ‘Rule priority’ and ‘Rule action’ fields are left unchanged.

When rules are added to or subtracted from the ACL, the HTK tables are modified. One possible approach is to regenerate the entire sequence of HTK tables. This is somewhat time consuming. Fortunately, it is possible to formulate update procedures which use much less computational effort. These updated tables may not be quite as optimized as the tables constructed from scratch, but nonetheless afford adequate performance. Two alternative algorithms for HTK table modification are provided to accommodate ACL updates. The first algorithm is faster than the HTK table construction algorithm previously described in FIG. 2, because the first algorithm does not compute new hashmasks. The first algorithm rewrites the HTK table entries. The first algorithm maintains near-optimal performance. The second HTK table modification algorithm is much faster, but is somewhat less optimized in lookup performance. In cases where frequent updating of ACL's is required, it would be possible to handle most updates with the second algorithm, then periodically do a more thorough updating with the slower (first) algorithm.

The first algorithm option is quite similar to the HTK table construction described in FIG. 2, except that hashmask generation is left out. Instead of generating new hashmasks for the different HTK tables, the existing hashmasks are reused for the updated set of ACL rules. Since hashmask generation is the most time-consuming step of the HTK table construction, a considerable amount of computation time is saved. Furthermore, since new rules are likely to follow the demographics of the existing rule set (i.e. wild cards in similar bit positions), the existing HCL masks are likely to be effective in resolving these new rules.

This HTK table modification procedure follows the outline shown in FIG. 2, except that the computation of the hash mask, rule lists and rule templates shown in FIG. 3 is performed without choosing the hash mask bits (i.e., steps 320 and 340 are not performed).

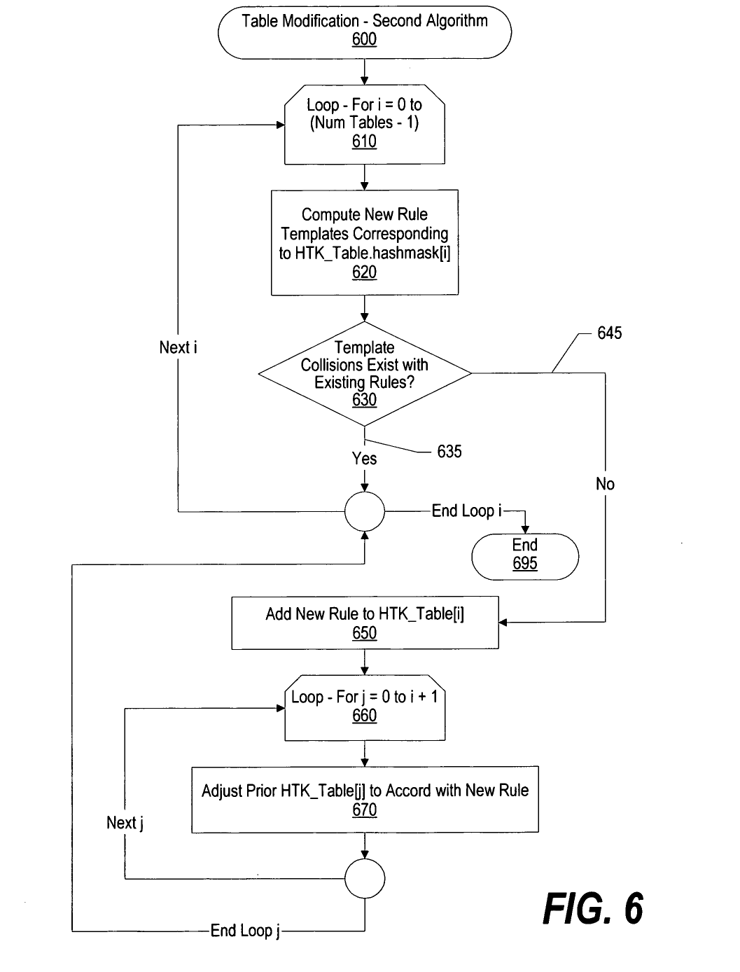

FIG. 6 depicts a flowchart for the second, faster, table modification algorithm. This flowchart presumes that a single rule is added. The stages of the HTK table modification algorithm are illustrated using a simple example. Suppose “ACL” in Table 1 is augmented with one additional rule, as shown in Table 18.

TABLE 18
Added “ACL” rule

| Rule priority | Rule | Rule mask | |
|---|---|---|---|
| 1 | 10000111 | 11001111 | |
| 2 | 10000110 | 11101110 | |
| 3 | 10000110 | 11001111 | |
| 4 | 11001111 | 11101111 | |
| 5 | 11110000 | 11110000 | |
| 6 | 10100000 | 11100000 | |
| 7 | 10111110 | 11111110 | [symbol] Ineffective Rule |
| 2.5 | 10000000 | 11110000 | [symbol] New Rule |

Rule 7 in Table is shown in italics, because it was previously determined that Rule 7 is ineffective. The new rule has been labeled “2.5” to indicate its relative priority in relation to the other rules.

The new rule templates are computed just as in HTK table creation, as described in FIG. 2. In FIG. 6, processing commences at 600 whereupon a loop is set up to loop through all of the tables (loop step 610). The new rule templates are looked up in the HTK tables selected during the loop, to see if they collide with an existing template. Formally, the procedure to compute new rule templates (step 620) and check for template collisions (decision 630) is as follows:
Loop through templates associated with rule and corresponding HTK table's mask:
   Form masked key associated with template.
   Read corresponding Key or Fail entry from HTK table
   If ‘Key’ entry:
      If ‘Rule priority’ field is not equal to 0×ffffff, then terminate. (New rule collides with an existing HTK table rule)
If loop completes without early termination, then no collisions are incurred by the new rule.

If there are table collisions with existing rules in the table selected in the loop, decision 630 branches to “yes” branch 635 whereupon processing loops back to select the next table in order to check the next table for collisions. When there are no template collisions with a selected table, decision 630 branches to “no” branch 645 where the new rule is added to the table selected during the loop (step 650). Addition of a rule to a specified HTK table (step 650) proceeds as follows:
Loop through templates associated with rule and corresponding HTK table's mask:
   Form masked key associated with template.
   Read corresponding Key or Fail entry from HTK table
   If ‘Key’ entry:
      Change the “Original key’ field (see FIG. 5) to the new rule;
      Change the five mask fields to agree with the new rule's masks (see FIG. 5);
      Set the “Valid termination” field equal to “Invalid termination” field value (see FIG. 5);
      Set the ‘Rule priority’ field (see FIG. 5) to a value which indicates the rule's ranking. For instance, suppose the new rule has priority greater than m+1 but less than m. The value 256*m+128 is then assigned to the ‘Rule priority’ field. This example shows why the factor 256 is used in rule priority assignment in the HTK table construction algorithm—the additional index space is used to fit in new rules. The value ‘256’ means that 255 new rules can be fit in between any two existing rules.
      Set the “Rule action” field (see FIG. 5) to conform to the new rule's action.
   If ‘Fail’ entry
      Change the “Hashmasked key bits” field to the new rule with HTK table's hashmask applied;
      Change the “Original key’ field (see FIG. 5) to the new rule;
      Change the five mask fields to agree with the new rule's masks (see FIG. 5);
      Set the “Valid termination” and “Invalid termination” fields equal to HTK_Table.lkp_trm for the current HTK table (see FIG. 5);
      Set the ‘Rule priority’ field (see FIG. 5) to a value which indicates the rule's ranking (use 256*m+128, as explained above).
      Set the “Rule action” field (see FIG. 5) to conform to the new rule's action.
End loop

Returning to FIG. 6, the loop beginning at 660 is used to adjust of prior tables (step 670) by looping through all tables that precede the selected table. The reason for such adjustments will be shown when the addition of a new rule requires changes in prior HTK tables. Upon inspection, it may be seen that newly added Rule 2.5 is not resolvable with Rules 1 2, or 3, but is resolvable with Rules 4,5, or 6. It follows that Rule 2.5 cannot be added to the first or second HTK table, but may be added to the third table (which contains only Rule 6).

Note that Rule 2.5 corresponds to templates {000,001,010,011} in HTK_Table[0] with hashmask 01001001. According to Table 14 and Table 15, these templates correspond to {Rule 3, Rule 1,Fail,Fail} respectively. For the two non-Fail entries, the “Valid termination” fields are {1,0}, while the “Invalid termination” fields are {1,1} (the ‘1’ values are assigned because HTK_Table.lkp_trm[0] is equal to 1, according to Table 16). However, now that new Rule 2.5 is included in HTK_Table[2], these “Valid termination” and “Invalid termination” fields are changed to {2,0} and {2,2} respectively. Furthermore, the HTK_Table.lkp_trm[0] field is changed to ‘2,’ because the Fail entries are still compatible with Rule 2.5 complicity.

The prior table adjustment when adding a new rule proceeds as follows:
Loop through templates associated with rule and prior HTK table's mask:
   Form masked key associated with template.
   Read corresponding Key or Fail entry from HTK table
   If ‘Key’ entry:
      Set ‘Invalid termination’ field equal to maximum of current “Invalid termination’ and new rule's table index
      If ‘Rule priority’ field is greater than new rule's priority, then set ‘Valid termination’ field equal to maximum of current “Valid termination’ and new rule's table index;
End loop
Set HTK_Table.lkp_trm for prior HTK table equal to the maximum of current HTK table is known. Rule removal performs the following steps:
Loop through templates associated with rule and corresponding HTK table's mask:
   Form masked key associated with template.
   Read corresponding Key entry from HTK table
   If ‘Invalid termination’ field is greater than lkp_trm from corresponding HTK table, then changes ‘Rule priority’ field to ‘0×ffffff’.
   Else if ‘Invalid termination’ field is equal to lkp_trm from corresponding HTK table, then change Key entry to Fail.
End loop

As an example of this algorithm, assume that Rule 1 is removed from the HTK tables for the simple set of rules in Table 1. Rule 1 is in the included rule set of HTK_Table[0]. Therefore the associated hashmask that is used is 01001001, according to Table 13. Rule 1 is associated with a unique rule template ‘001’, which has corresponding hash key 00000001. If this entry is retrieved, the “Invalid termination” field for this entry is equal to ‘2’ which is equal to HTK_Table.lkp_trm[0]. It follows that the Key entry can be entirely removed from HTK_Table[0].

As a second example, assume that Rule 4 is removed. Rule 4 is also in the included rule set of HTK_Table[0], with unique rule template ‘111’ corresponding to hash key 01001001. If this entry is retrieved, the “Invalid termination” field for this entry is equal to ‘2’ (because of Rule 6-see Table 15). It follows that the “Rule priority” field is changed to “0×ffffff’, and otherwise the entry is left intact.

The lookup procedure is diagrammed in FIG. 1. Below, additional details are provided pertaining to the steps in the flowchart shown in FIG. 1. Before each lookup, four variables in CPU memory are initialized, using the values given in Table 19.

TABLE 19
Initial values for ACL lookup

| Variable description | Initial value |
|---|---|
| Current HTK table indicator | 0 |
| Termination indicator | 0xff |
| Final rule priority | 0xffff |
| Final action | deny |

In FIG. 1, steps 140 and 145 are used to mask key (step 140) and send to TLU (step 145). Here the original key (concatenated fields) is masked with the hashmask specified by HTK_Table.hashmask for the current HTK table. Step 150 performs an HTK lookup. In step 150, the hashmasked key is used as key into the current HTK table. The lookup will end at either a Key or a Fail entry. If Key, then the key data will be passed back to the CPU.

If Key, then decision 155 branches to “yes” branch 158 whereupon a determination is made as to whether the rule was found (decision 160). Here the “Rule priority” field of the retrieved data is examined. If the value is 0×ffff, then no rule is indicated and decision 160 branches to “no” branch 156, otherwise processing continues to decision 170.

A determination is made as to whether a rule that was found is valid (decision 170). Here the “Rule key” from the retrieved data is compared with the original key masked according to the five prefix mask fields in the key data. If the “rule key” agrees with the original key masked according to the five prefix mask fields, then the rule is valid and decision 170 branches to “yes” branch 174. On the other hand, if the rule key does not agree with the original key masked according to the five prefix mask fields, then the rule is not valid and decision 170 branches to “no” branch 172.

If the rule is valid (decision 170 branching to “yes” branch 174), the rule priority (obtained from the key data) is compared with the priority of the current final rule. A determination is made as to whether the new rule's priority value is lower (indicating higher priority), than the final rule priority and action are reset to agree with the new rule (decision 175). If the new rule has a higher priority, then decision 175 branches to “yes” branch 178 whereupon this rule is set to be the last rule found (replacing a default rule or any previous rule that was last found from another HTK table).

A determination is made as to whether to terminate looking through the HTK tables (decision 185). This determination is based upon updating a termination indicator and checking whether checking can be terminated. There are three possible outcomes: (1) New rule has been validated; (2) New rule has been invalidated, or no new rule found; (3) No entry (Fail).
If the new rule has been validated (case (1)), then the termination indicator is set as the minimum of the current termination indicator and the ‘Valid termination’ field;
If the new rule has been invalidated, or no new rule found (case (2)), then the termination indicator is set as the minimum of the current termination indicator and the ‘Invalid termination’ field; and
If no entry was found, i.e., the lookup failed, (case (3)), then the termination indicator is set as the minimum of the current termination indicator and HTK_Table.lkp_trm for the current HTK table.

If the termination indicator is less than or equal to the current table indicator, then lookup is terminated and decision 185 branches to “yes” branch 192. The final step in decision 185 is to update the table indicator. This is performed by incrementing the table indicator by 1. On the other hand, if the termination indicator is greater than the current table indicator, then lookup continues and decision 185 branches to “no” branch 188 whereupon, at step 190, the predefined mask for the next rule set is selected and processing loops back to perform a lookup using the next predefined mask and rule set. This looping continues until either all rule sets have been searched or when decision 185 branches to “yes” branch 192. At step 195, the last rule that was found (i.e., the rule with the highest priority) is applied. For example, if the last rule was to “accept” the packet, then the request is accepted and if the last rule was to “deny” the packet, then the request is denied.

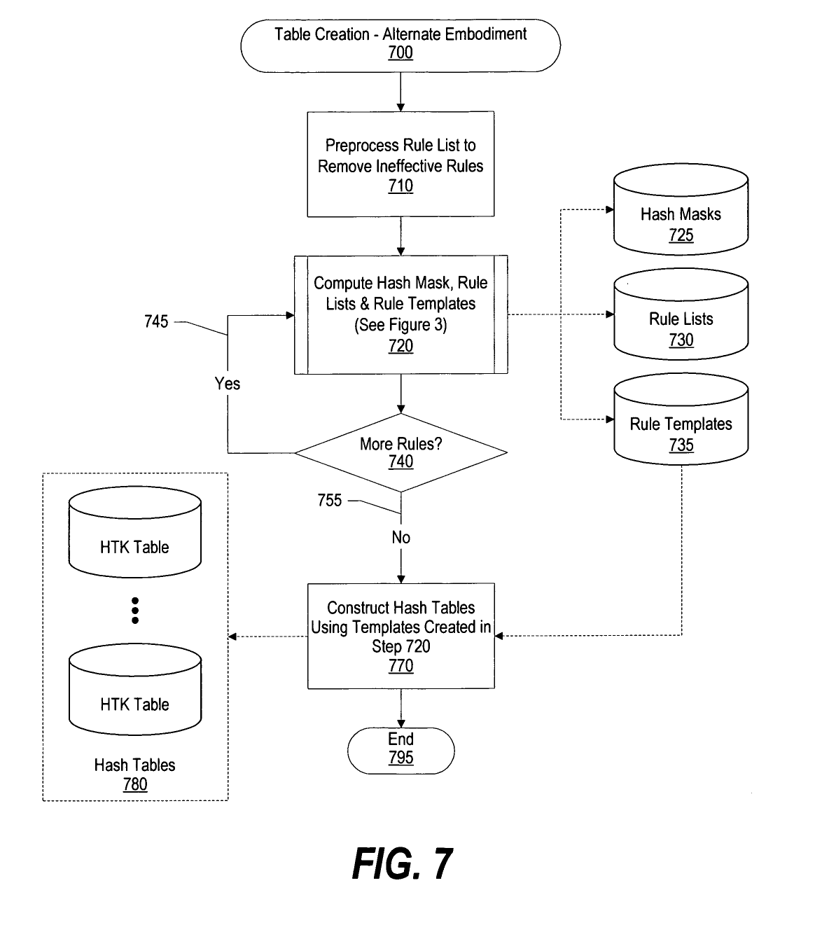

FIG. 7 is a flowchart showing an alternate approach for table creation. FIG. 7 is much like FIG. 2 and the reference numerals align accordingly (e.g., step 210 is the same as step 710, etc.). However, in FIG. 7 rule templates and information for lookup termination are not computed. Hence, step 260 exists in FIG. 2 but there is no corresponding step 760 in FIG. 7.

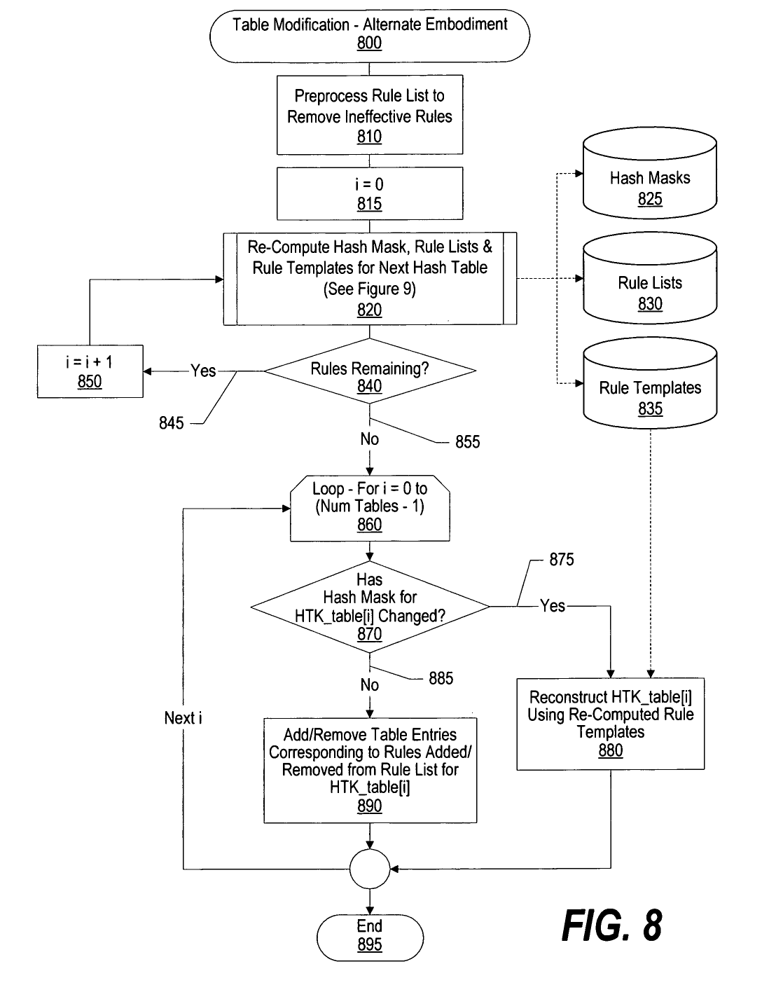

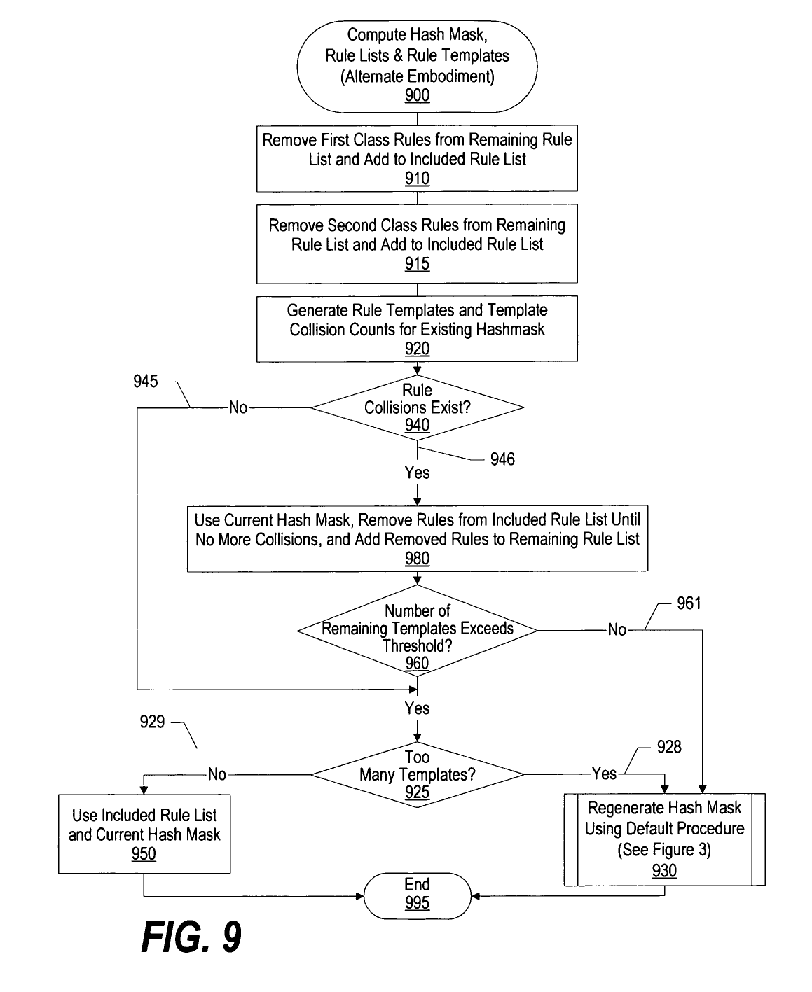

FIG. 8 is a flowchart showing an alternate approach for table modification that modifies the tables that were created using the alternate approach shown in FIG. 7. In FIG. 8, processing commences at 800 whereupon, at step 810 the rule list is preprocessed in order to remove ineffective rules (for details regarding the removal of ineffective rules, see FIG. 2, step 210, and details pertaining thereto). At step 815, a counter (i) is initialized to 0. The hash mask, rule lists, and rule templates are then recomputed for the next hash table (HTK_table[i]) at predefined process 820 (see FIG. 9 and corresponding text for processing details). This results in recomputed hash masks 825, recomputed rule lists 830, and recomputed rule templates 835. A determination is made as to whether there are additional rules remaining (decision 840). If there are-more rules to be processed, decision 840 branches to “yes” branch 845 whereupon, at step 850, the counter is incremented and processing loops back to predefined process 820 to recomputed the hash mask, rule lists, and rule templates for the next hash table. This looping continues until there are no more rules remaining to be processed, at which point decision 840 branches to “no” branch 855.

A loop is initialized at step 860 to loop through all of the hash tables. For each hash table, a determination is made as to whether the hash mask (recomputed in predefined process 820) has changed for the selected table (decision 870). If the hash mask has changed for the selected table, decision 870 branches to “yes” branch 875 whereupon, at step 880, the selected hash table is reconstructed using the recomputed rule template. On the other hand, if the hash mask has not changed, decision 870 branches to “no” branch 885 whereupon, at step 890, table entries are added and/or removed corresponding to the rules that have been added and/or removed for the selected table. Once all of the tables have been processed, the loop that was initialized in step 860 ends and processing ends at 890.

FIG. 9 is a flowchart showing the steps taken in computing a hash mask, rule lists, and rule templates for the alternate approach shown in FIG. 8. Processing commences at 900 whereupon, at step 910, first class rules are removed from the remaining rule list and added to the included rule list. This step is the same as step 310 shown on FIG. 3. For details, see the description for step 310 of FIG. 3 and details previously provided for handling first class rules. At step 915, second class rules are removed from the remaining rule list and added to the included rule list. This step is the same as step 315 shown on FIG. 3. For details, see the description for step 315 of FIG. 3 and details previously provided for handling second class rules. At step 920, rule templates and template collision counts are generated for the existing hashmask. The computation of templates and collision counts in step 920 are the same as in steps 325 and 350 shown in FIG. 3. Next, a determination is made as to whether rule collisions exist (decision 940). If rule collisions exist, decision 940 branches to ‘yes’ branch 946, whereupon rules are removed one by one from the included rule list according to a specified order (step 980). The process in 980 ends when there are no more template collisions for the rules remaining in the included rule list, when the templates are computed using the existing hashmask. Following step 980, a determination is made as to whether the number of remaining templates surpasses a specified threshold (decision 960). If the number of templates does not surpass the given threshold, then decision 960 branches to “No” branch 961, whereupon the hash mask is regenerated using the default procedure shown in FIG. 3 (predefined process 930) and processing ends at 995. If the number of remaining templates surpasses the given threshold, decision 960 branches to “Yes” branch 964 which leads to decision 925. If no rule collisions exist in decision 940, decision 940 branches to “No” branch 945 which also leads to decision 925. In decision 925, a determination is made as to whether the number of templates is too large, by comparing the number of templates with a predefined threshold. If there are too many templates, decision 925 branches to “yes” branch 928 whereupon the hash mask is regenerated using the default procedure shown in FIG. 3 (predefined process 930) and processing ends at 995. On the other hand, if there are not too many templates, decision 925 branches to “no” branch 929 whereupon, at step 950, the included rule list and the current hash mask will be used and processing ends at 995.

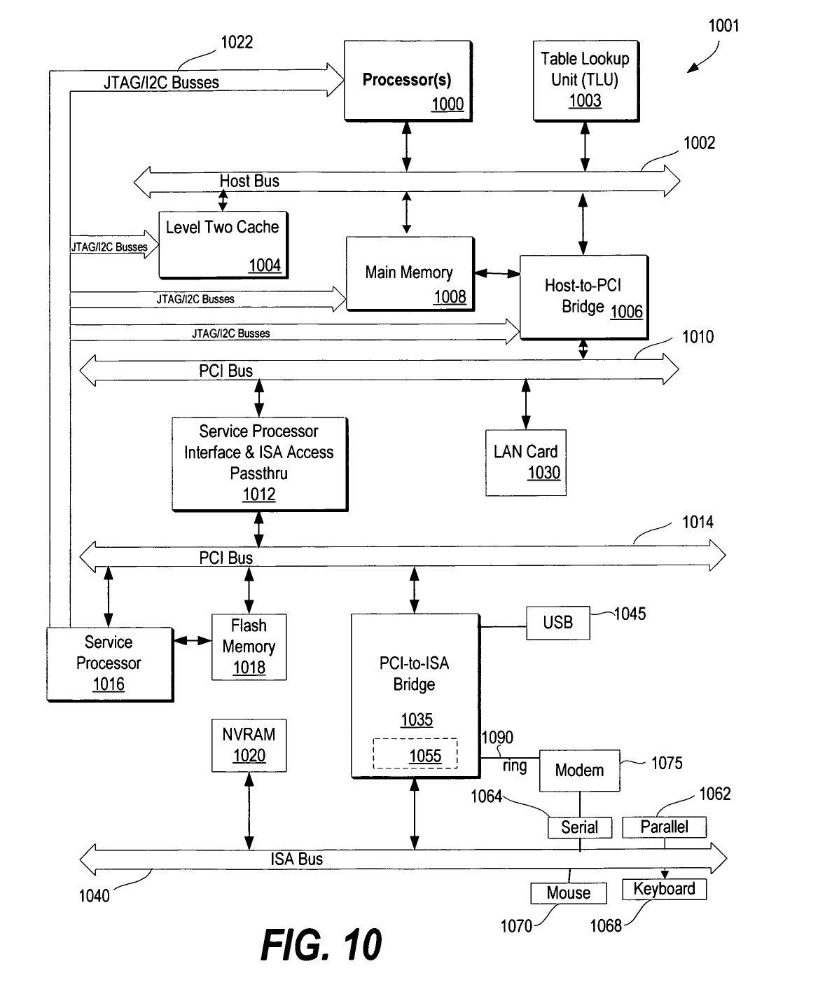

FIG. 10 illustrates information handling system 1001 which is a simplified example of a computer system capable of performing the computing operations of the host computer described herein with respect to a preferred embodiment of the present invention. Computer system 1001 includes processor 1000 which is coupled to host bus 1002. A table lookup unit (TLU 1003) and a level two (L2) cache memory 1004 are also coupled to host bus 1002. Host-to-PCI bridge 1006 is coupled to main memory 1008, includes cache memory and main memory control functions, and provides bus control to handle transfers among PCI bus 1010, processor 1000, L2 cache 1004, main memory 1008, and host bus 1002. Main memory 1008 is coupled to Host-to-PCI bridge 1006 as well as host bus 1002. Devices used solely by host processor(s) 1000, such as LAN card 1030, are coupled to PCI bus 1010. Service Processor Interface and ISA Access Pass-through 1012 provide an interface between PCI bus 1010 and PCI bus 1014. In this manner, PCI bus 1014 is insulated from PCI bus 1010. Devices, such as flash memory 1018, are coupled to PCI bus 1014. In one implementation, flash memory 1018 includes BIOS code that incorporates the necessary processor executable code for a variety of low-level system functions and system boot functions.

PCI bus 1014 provides an interface for a variety of devices that are shared by host processor(s) 1000 and Service Processor 1016 including, for example, flash memory 1018. PCI-to-ISA bridge 1035 provides bus control to handle transfers between PCI bus 1014 and ISA bus 1040, universal serial bus (USB) functionality 1045, power management functionality 1055, and can include other functional elements not shown, such as a real-time clock (RTC), DMA control, interrupt support, and system management bus support. Nonvolatile RAM 1020 is attached to ISA Bus 1040. Service Processor 1016 includes JTAG and I2C buses 1022 for communication with processor(s) 1000 during initialization steps. JTAG/I2C buses 1022 are also coupled to L2 cache 1004, Host-to-PCI bridge 1006, and main memory 1008 providing a communications path between the processor, the Service Processor, the L2 cache, the Host-to-PCI bridge, and the main memory. Service Processor 1016 also has access to system power resources for powering down information handling device 1001.

Peripheral devices and input/output (I/O) devices can be attached to various interfaces (e.g., parallel interface 1062, serial interface 1064, keyboard interface 1068, and mouse interface 1070 coupled to ISA bus 1040. Alternatively, many I/O devices can be accommodated by a super I/O controller (not shown) attached to ISA bus 1040.

In order to attach computer system 1001 to another computer system to copy files over a network, LAN card 1030 is coupled to PCI bus 1010. Similarly, to connect computer system 1001 to an ISP to connect to the Internet using a telephone line connection, modem 1075 is connected to serial port 1064 and PCI-to-ISA Bridge 1035.

While the computer system described in FIG. 10 is capable of executing the processes described herein, this computer system is simply one example of a computer system. Those skilled in the art will appreciate that many other computer system designs are capable of performing the processes described herein.

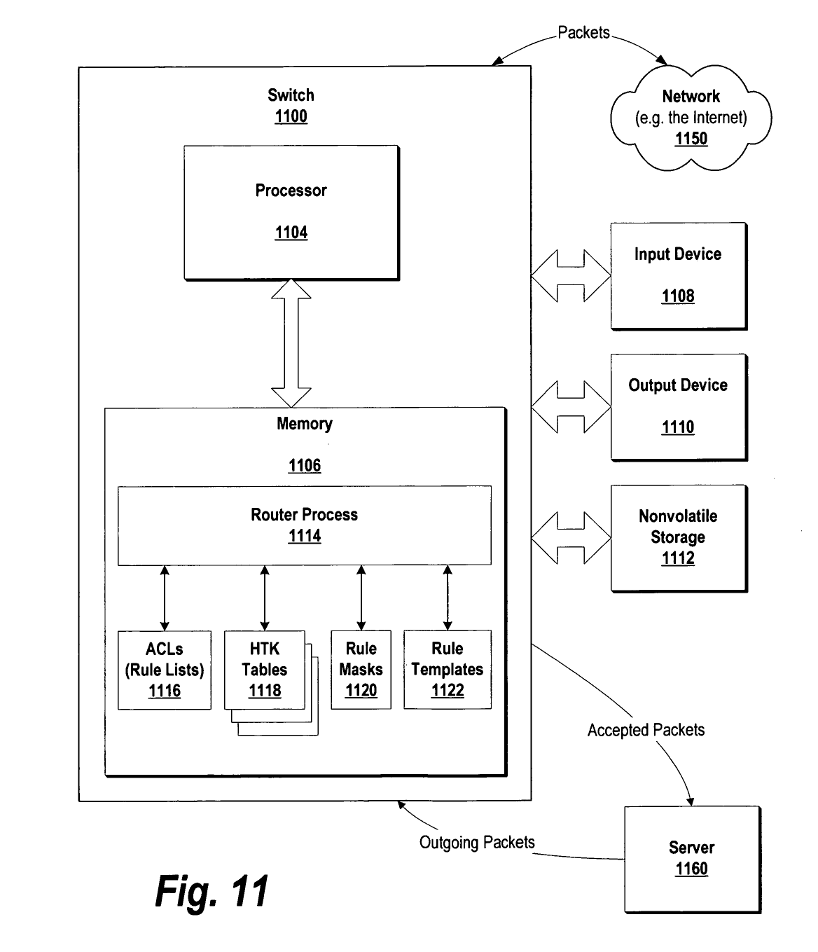

FIG. 11 illustrates router 1100 which is a simplified example of a router capable of performing the routing operations described herein. Router 1100 is shown include a processor, or processors 1104, and a memory 1106. Router management process 1114 is shown to be resident in memory 1106 and manages Rule Lists (ACLs 1116), HTK tables 1118, Rule Masks 1120, and Rule Templates 1122, as described herein in order to manage access. An input device 1108 and an output device 1110 are connected to computer system 1102 and represent a wide range of varying I/O devices such as disk drives, keyboards, modems, network adapters, printers and displays. Nonvolatile storage device 1112, includes a disk drive, nonvolatile memory, optical drive, or any other nonvolatile storage device, is shown connected to computer system 1102. In one aspect, router 1100 is used to filter incoming packets received from network 1150, such as the Internet. Packets that are accepted after being processed by router process 1114 using ACLs 1116, HTK tables 1118, rule masks 1120, and rule templates 1122 are passed to server 1160 for processing. Router 1100 may also be used to receive outgoing packets from server 1160 and transmit them to a device interconnected to the router via network 1150.

While the router described in FIG. 11 is capable of executing the invention described herein, this device is simply one example of a router. Those skilled in the art will appreciate that many other router designs are capable of performing the invention described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A computer-implemented method for retrieving access rules, the method comprising:
receiving an incoming packet that includes a plurality of fields;
forming an original key from a plurality of the fields;
masking the original key using one or more predefined masks, the predefined masks each corresponding to a different lookup table and the masking resulting in one or more masked keys;
searching the lookup tables for the masked keys, the searching resulting in one or more corresponding rules;
selecting the corresponding rule from the one or more corresponding rules based on a priority corresponding to each of the corresponding rules; and
applying the selected rule.

2. The method of claim 1 wherein the lookup tables are hash-trie-key (HTK) tables.

3. The method of claim 1 wherein one of the corresponding rules is a default rule and wherein the default rule is selected in response to the searching failing to find the masked keys in the lookup tables.

4. The method of claim 1 wherein the searching further comprises:
successfully locating one or more of the masked keys in one or more of the lookup tables; and
comparing the original key to one or more possible rules, wherein one of the possible rules corresponds to each of the entries in the lookup tables where the masked keys were successfully located.

5. The method of claim 4 further comprising:
in response to each successful comparison where the original key matches one of the possible rules, determining whether the possible rule is valid; and
only including valid rules in the one or more corresponding rules.

6. The method of claim 1 wherein the masking and the searching further includes:
masking the original key using a first predefined mask that corresponds to a first lookup table selected from the one or more lookup tables, the masking forming a first masked key;
searching the first lookup table for the first masked key;
in response to finding the first masked key in an entry of the first lookup table:
validating a first rule that corresponds to the entry of the first lookup table, the validating performed in response to the original key matching the first rule; and
storing the first rule in a storage location in response to the first rule being successfully validated.

7. The method of claim 6 further comprising:
masking the original key using a second predefined mask that corresponds to a second lookup table selected from the one or more lookup tables, the masking forming a second masked key;
searching the second lookup table for the second masked key;
in response to finding the second masked key in an entry of the second lookup table:
validating a second rule that corresponds to the entry of the second lookup table, the validating performed in response to the original key matching the second rule;
comparing the priority of the second rule to the priority of the stored first rule in response to the second rule being successfully validated; and
storing the second rule in the storage location in response to the second rule's priority being higher than the first rule's priority.

8. The method of claim 7 wherein the applying further comprises:
retrieving the rule that is stored in the storage location, wherein the rule that is stored is selected from the group consisting of the first rule and the second rule; and
applying the retrieved rule.

9. The method of claim 6 further comprising:
determining whether searching can be terminated after searching the first lookup table;
in response to the determination:
searching one or more additional lookup tables in response to determining that searching cannot be terminated; and
applying the first rule without searching additional lookup tables in response to determining that searching can be terminated.

10. The method of claim 1 further comprising:
in parallel, searching a plurality of the lookup tables, the searching resulting in the corresponding rules; and
selecting the corresponding rule with the highest priority from the corresponding rules.

11. The method of claim 1 further comprising:
sending the masked key to a table lookup unit (TLU), wherein the searching is performed by the TLU.

12. The method of claim 1 further comprising:
updating the access rules, the updating including:
computing a new rule template for one or more of the lookup tables, wherein the computing incorporates a new rule;
identifying one of the lookup tables where the new rule template does not cause a collision with existing rules corresponding to the identified lookup table; and
adding the new rule to the identified lookup table in response to the identifying.

13. The method of claim 12 further comprising:
adjusting one or more of the non-identified lookup tables so that the adjusted tables are in accordance with the new rule added to the identified table.

14. A data processing system comprising:
one or more processors;
a memory array accessible by the processors;
a network connection that connects the data processing system to a computer network;
a set of instructions stored in the memory, wherein one or more of the processors executes the set of instructions in order to perform actions of:
receiving, from the network connection, an incoming packet that includes a plurality of fields;
forming an original key from a plurality of the fields;
masking the original key using one or more predefined masks, the predefined masks each corresponding to a different lookup table and the masking resulting in one or more masked keys;
searching the lookup tables for the masked keys, the searching resulting in one or more corresponding rules;
selecting the corresponding rule from the one or more corresponding rules based on a priority corresponding to each of the corresponding rules; and
applying the selected rule.

15. The data processing system of claim 14 further comprising:
a table lookup unit (TLU) accessible by at least one of the processors, wherein the instructions executed by one of the processors further performs the actions of:
sending the masked key to the table lookup unit, wherein the searching is performed by the TLU.

16. The data processing system of claim 14 wherein the searching further comprises instructions that perform the actions of:
successfully locating one or more of the masked keys in one or more of the lookup tables;
comparing the original key to one or more possible rules, wherein one of the possible rules corresponds to each of the entries in the lookup tables where the masked keys were successfully located;
in response to each successful comparison where the original key matches one of the possible rules, determining whether the possible rule is valid; and
only including valid rules in the one or more corresponding rules.

17. The data processing system of claim 14 wherein the masking and the searching further comprises instructions that perform the actions of:
masking the original key using a first predefined mask that corresponds to a first lookup table selected from the one or more lookup tables, the masking forming a first masked key;
searching the first lookup table for the first masked key;
in response to finding the first masked key in an entry of the first lookup table:
validating a first rule that corresponds to the entry of the first lookup table, the validating performed in response to the original key matching the first rule; and
storing the first rule in a storage location in response to the first rule being successfully validated.

18. A computer program product stored in a computer readable medium, comprising functional descriptive material that, when executed by a data processing system, causes the data processing system to perform actions that include:
receiving an incoming packet that includes a plurality of fields;
forming an original key from a plurality of the fields;
masking the original key using one or more predefined masks, the predefined masks each corresponding to a different lookup table and the masking resulting in one or more masked keys;
searching the lookup tables for the masked keys, the searching resulting in one or more corresponding rules;
selecting the corresponding rule from the one or more corresponding rules based on a priority corresponding to each of the corresponding rules; and
applying the selected rule.

19. The computer program product of claim 18 wherein the searching further comprises functional descriptive material that, when executed by a data processing system, causes the data processing system to perform actions that include:
successfully locating one or more of the masked keys in one or more of the lookup tables;
comparing the original key to one or more possible rules, wherein one of the possible rules corresponds to each of the entries in the lookup tables where the masked keys were successfully located;
in response to each successful comparison where the original key matches one of the possible rules, determining whether the possible rule is valid; and
only including valid rules in the one or more corresponding rules.

20. The computer program product of claim 18 wherein the masking and the searching further comprises instructions that perform the actions of:
masking the original key using a first predefined mask that corresponds to a first lookup table selected from the one or more lookup tables, the masking forming a first masked key;
searching the first lookup table for the first masked key;
in response to finding the first masked key in an entry of the first lookup table:
validating a first rule that corresponds to the entry of the first lookup table, the validating performed in response to the original key matching the first rule; and
storing the first rule in a storage location in response to the first rule being successfully validated.
